(19) United States
(12) Patent Application Publication
(10) Pub. No.: US 2009/0260577 A1
(43) Pub. Date: Oct. 22, 2009

(54) Cat litter box

(75) Inventor: Ronald Anthony Lewis, II, St. Louis, MO (US)

Correspondence Address: K&L Gates LLP, P.O. Box 1135, CHICAGO, IL, 60690, US

(73) Assignee: Nestec Ltd., Vevey (CH)

(21) Appl. No.: 12/454,991

(22) Filed: May 26, 2009

Related U.S. Application Data
(63) Continuation of application No. 10/976,052, filed on Oct. 27, 2004.
(60) Provisional application No. 60/518,477, filed on Nov. 6, 2003.

(51) Int. Cl. A01K 29/00

(52) U.S. Cl. 119/165

(57) ABSTRACT

A pet litter box including a body defined by a top portion and a bottom portion, the top portion including a portion that is hingedly connected to other portions of the litter box to allow at least a portion thereof to be pivoted away from other portions of the body, the top including an opening for allowing a pet to enter an interior defined by the body of the cat litter box is provided.

### PRIORITY CLAIM

This application claims the benefit of U.S. Provisional Patent Application No. 60/518,477, filed Nov. 6, 2003, the disclosures of which are hereby incorporated by reference.

### BACKGROUND OF THE INVENTION

The present invention relates to pets and pet care. More specifically, the present invention relates to cat litter boxes.

### SUMMARY OF THE INVENTION

The present invention relates to new and improved designs for pet litter boxes. The design and structure of the pet litter box provides many useful features to the pet owner. Although the pet litter box is in a preferred embodiment designed for cats, it should be appreciated that it can be designed for use with other pets.

Generally, the pet litter box has a top and a bottom component. The top component preferably includes a hingable portion with an opening for the cat to enter and exit.

In an embodiment, the present invention provides a pet litter box comprising a body defined by a top portion and a bottom portion, the top portion including a portion that is hingedly connected to other portions of the body of the litter box to allow at least a portion thereof to be pivoted away from other portions of the body, the top including an opening for allowing a pet to enter an interior defined by the body of the cat litter box.

In an embodiment, the present invention provides a pet litter box wherein the litter box is designed for a cat.

In an embodiment, the present invention provides a pet litter box wherein the opening is in the shape of a cat face.

In an embodiment, the present invention provides a pet litter box wherein the top portion can be stored inside the bottom portion in a nestable fashion.

In an embodiment, the present invention provides a pet litter box wherein the interior is defined in part by a bottom portion and the bottom portion includes at least eight textured portions.

In an embodiment, the present invention provides a pet litter box wherein an outer portion of the litter box includes a handle.

In an embodiment, the present invention provides a pet litter box including at least one side vent and a charcoal vent.

In an embodiment, the present invention provides a pet litter box including a friction snap to allow the portion that is hingedly connected to be removably secured to remaining portions of the body.

In an embodiment, the present invention provides a cat litter box having a plastic body including a top and a bottom, the top and the bottom defining an interior therein including a bottom portion for receiving cat litter, at least a portion of the top of the body being hingedly connected to other portions of the body to allow a portion thereof to pivot, the pivoting portion including an opening for allowing a cat to enter and exit the pet litter box, and the cat litter box including at least one side vent and charcoal vent.

In an embodiment, the present invention provides a pet litter box wherein the opening is in the shape of a cat face.

In an embodiment, the present invention provides a pet litter box wherein the top portion can be stored inside the bottom portion in a nestable fashion.

In an embodiment, the present invention provides a pet litter box wherein the interior is defined in part by a bottom portion and the bottom portion includes at least eight textured portions.

In an embodiment, the present invention provides a pet litter box including a friction snap to allow the portion that is hingedly connected to be removably secured to remaining portions of the body.

An advantage of the present invention is to provide an improved cat litter box.

Still further, an advantage of the present invention is to provide an improved design for a cat litter box.

Another advantage of the present invention is to provide an improved plastic cat litter box.

Still, an advantage of the present invention is to provide a cat litter box that has a fanciful design, such as an opening in the shape of a can's face.

Furthermore, an advantage of the present invention is to provide a cat litter box that is nestable with other cat litter boxes allowing the products to easily be stored at a retailer.

Additional features and advantages of the present invention are described in, and will be apparent from, the following Detailed Description of the Invention and the figures.

### BRIEF DESCRIPTION OF THE FIGURES

FIG. 1 illustrates various views of an embodiment of the cat litter box of the present invention and specifically an assembly of same.

FIG. 2 illustrates bottom views of the cat litter box of FIG. 1.

FIG. 3 illustrates views of an embodiment of the lid of the cat litter box of FIG. 1.

FIG. 4 illustrates an embodiment of the top of the cat litter box of FIG. 1.

FIG. 5 illustrates perspective views of an embodiment of the cat litter box of the present invention.

FIG. 6 illustrates a perspective view of another embodiment of the cat litter box of the present invention.

FIG. 7 illustrates a perspective view of another embodiment of the cat litter box of the present invention.

FIG. 8 illustrates a perspective view of another embodiment of the cat litter box of the present invention.

FIG. 9 illustrates a perspective view of another embodiment of the cat litter box of the present invention.

FIG. 10 illustrates a perspective view of another embodiment of the cat litter box of the present invention.

FIG. 11 illustrates a perspective view of another embodiment of the cat litter box of the present invention.

FIG. 12 illustrates a perspective view of another embodiment of the cat litter box of the present invention.

FIG. 13 illustrates as A through F embodiments of the opening of the cat litter box of the present invention.

FIG. 14 illustrates as A through F embodiments of the handle for the cat litter box of the present invention.

FIG. 15 illustrates as A through F embodiments of a latch for the cat litter box of the present invention.

FIG. 16 illustrates as A through F embodiments of vents for the cat litter box of the present invention.

### DETAILED DESCRIPTION OF THE PRESENTLY PREFERRED EMBODIMENTS

The present invention provides improved pet and cat litter boxes. Of course, it is known in the art to provide litter boxes so as to allow a sanitary area for a cat, or other small pet, to urinate and/or defecate. These litter boxes provide a structure in which to house cat litter or other absorbent material for receiving the pet waste.

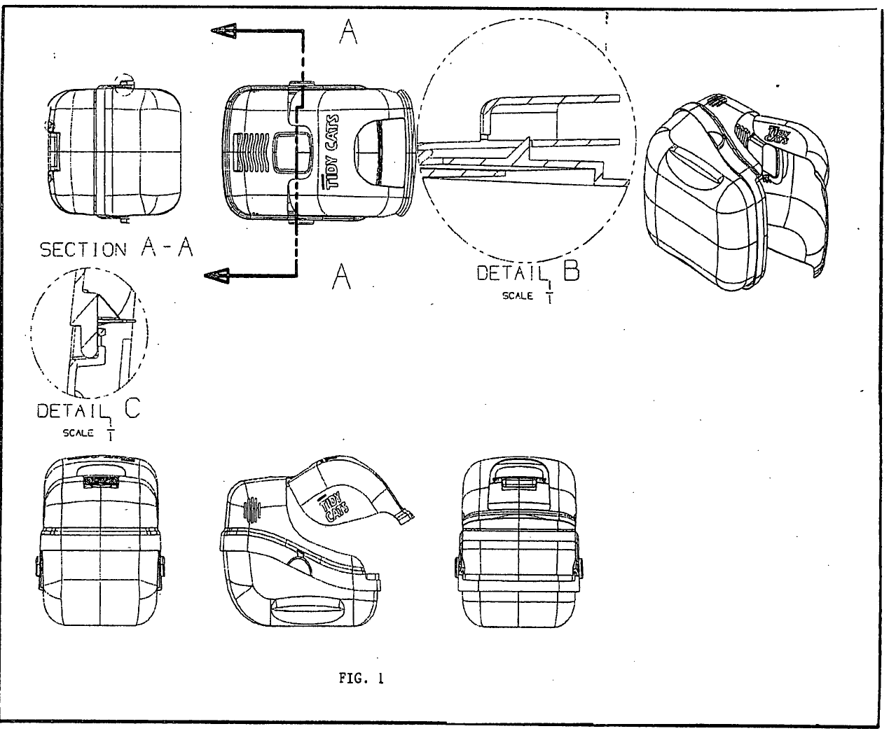

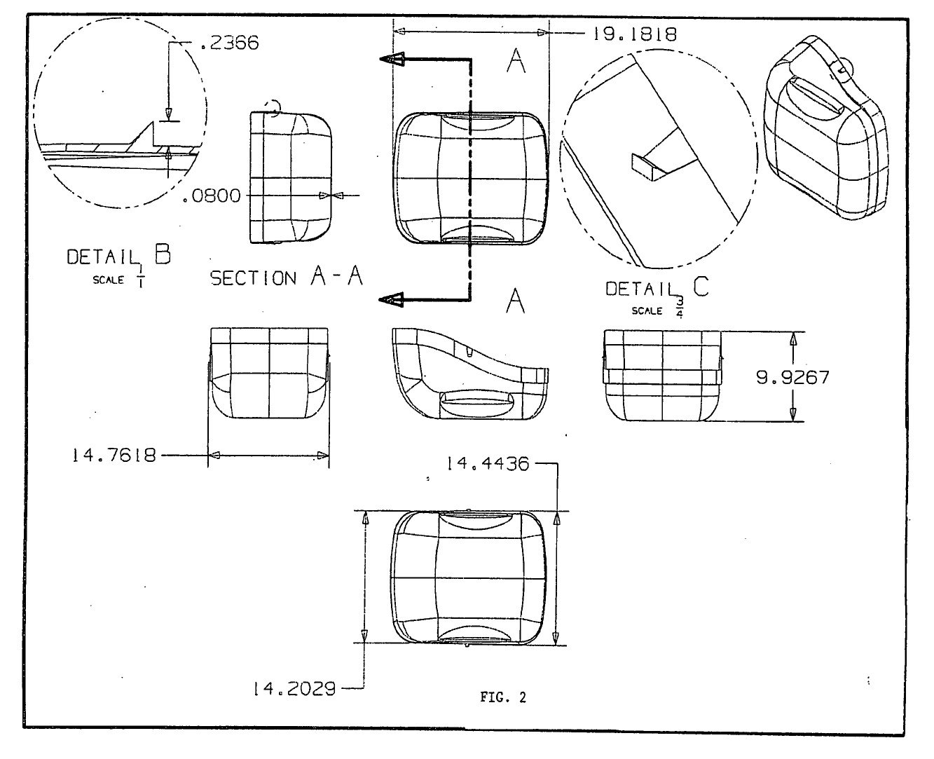

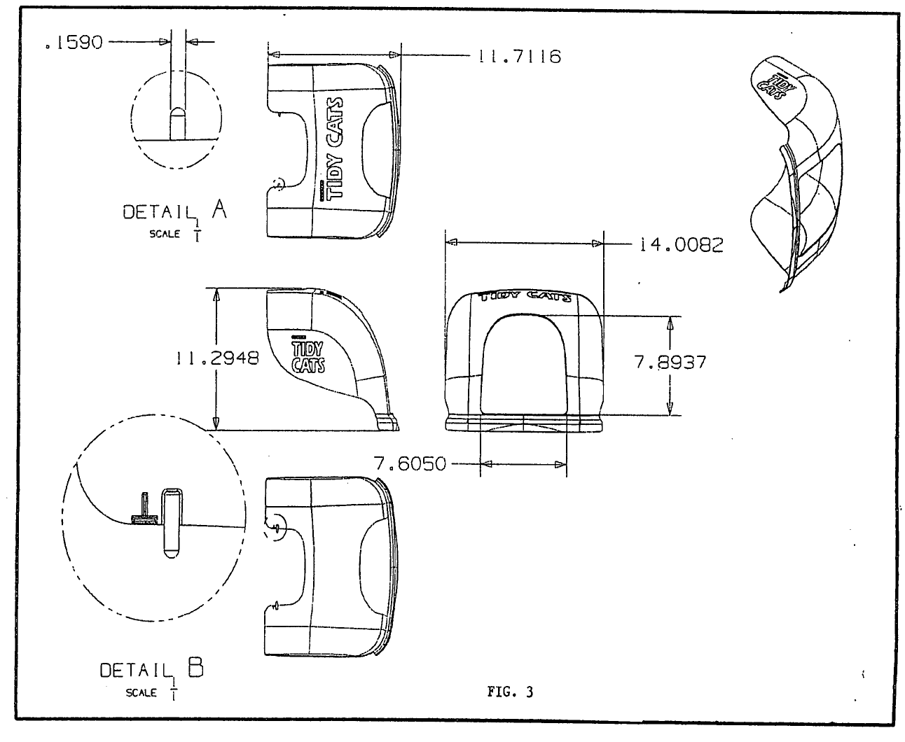

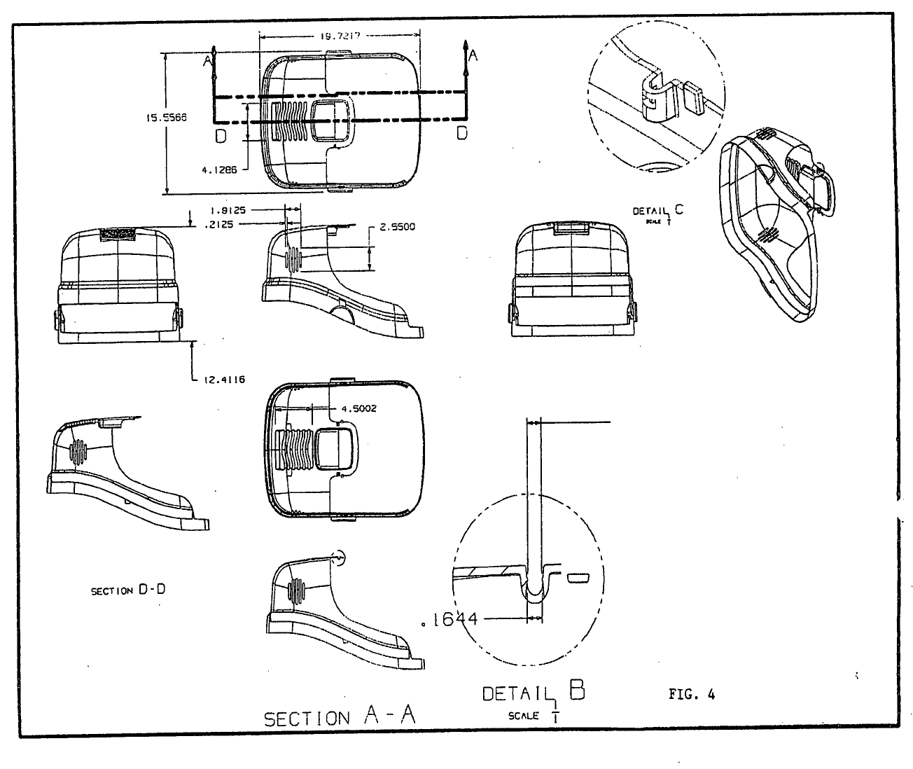

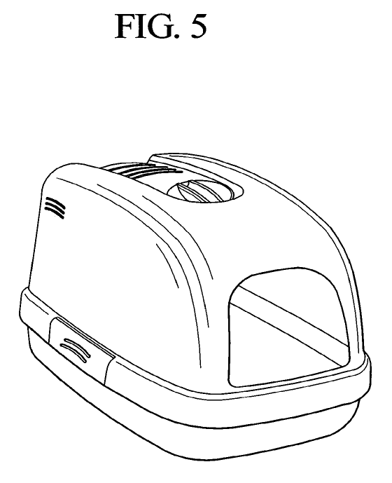

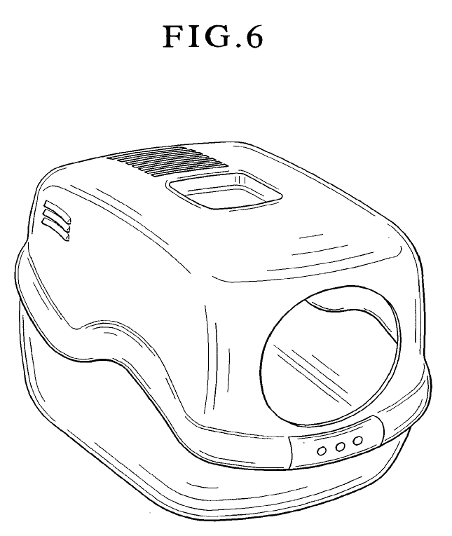

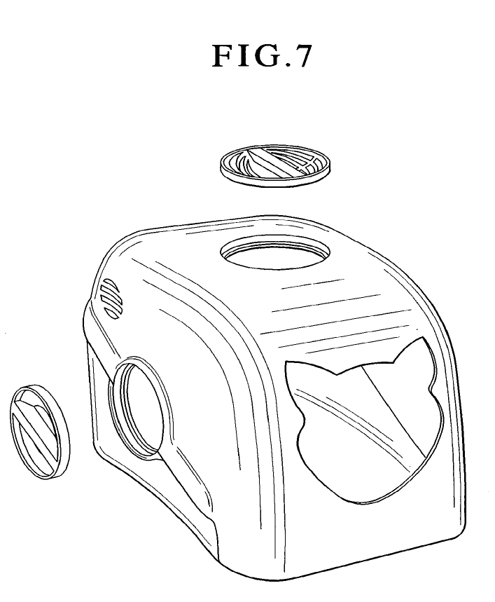

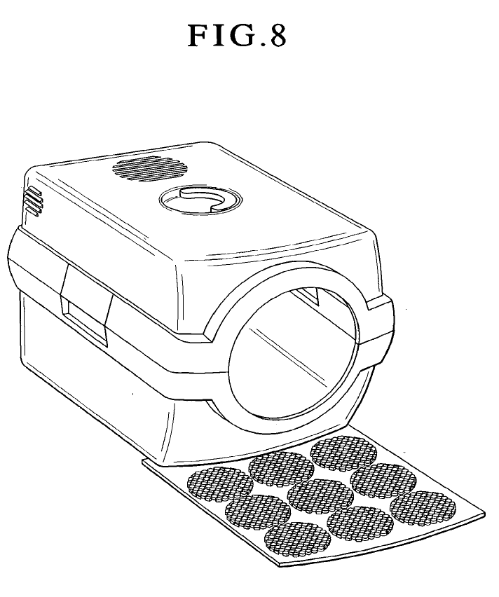

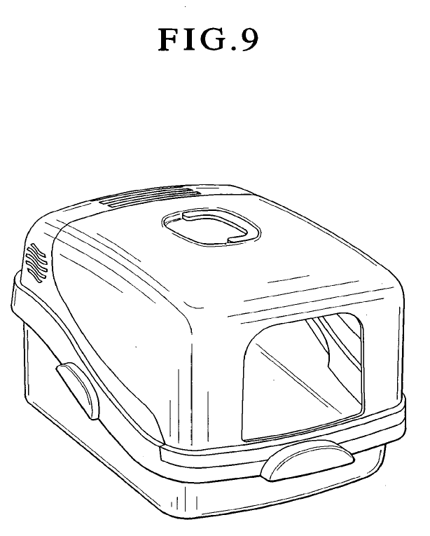

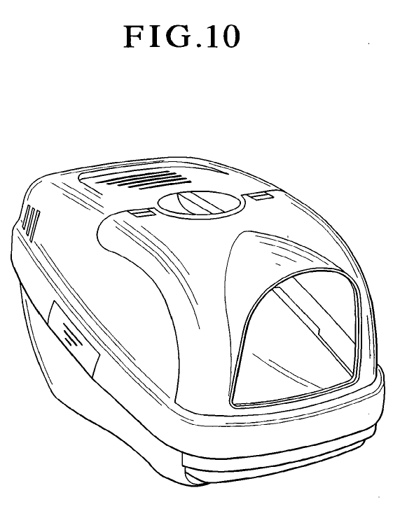

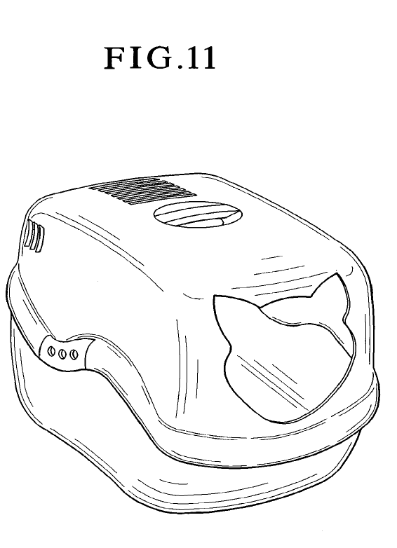

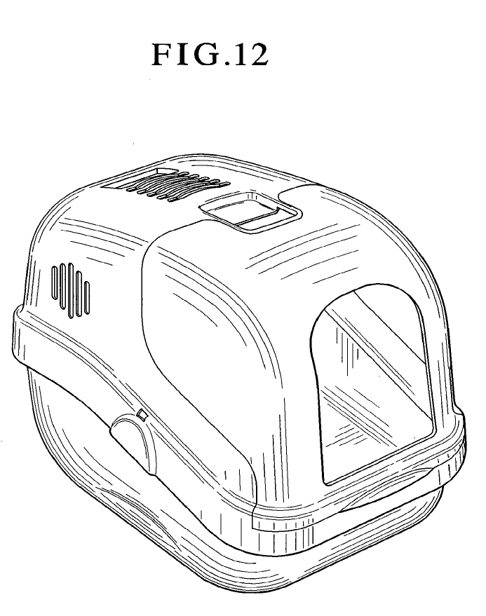

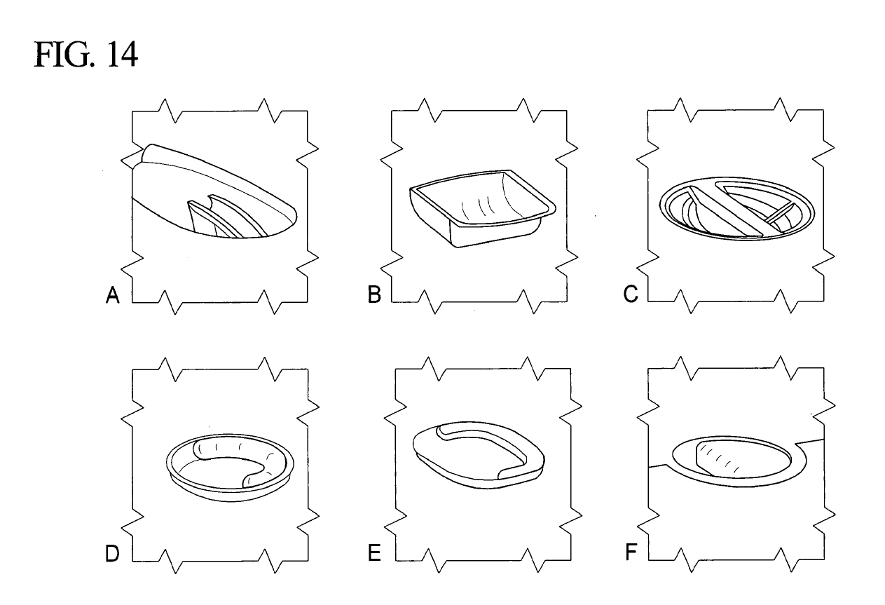

As set forth in FIGS. 1-16, various designs and embodiments of the cat litter box of the present invention are provided. Generally, as illustrated in FIG. 1, the cat litter box has a top and a bottom component. The top component further includes a part that is hinged. The hinged portion allows one access to an interior of the cat litter box. In the illustrated embodiments, the hinged top portion includes an opening for the cat, or other pet, to enter and exit.

Preferably, the litter box is nestable. To this end, the top, when not in use, can be inserted into the bottom. This allows multiple litter boxes to be stacked on top of one another. The nestable feature provides a compact design for the retailer in stocking/dispensing the litter boxes to customers.

Preferably, the front of the litter box has a friction snap to lock the top to the bottom. Thus, the pet can enter and exit the litter box without the top portion opening. The top of the litter box is hinged to the remaining portions by, preferably, at least two hinges to allow it to swing up.

The litter box defines an interior for receiving the cat litter. This interior includes a bottom portion on which the cat litter is located. Preferably, the bottom of the cat litter box is textured. Preferably, there are a minimum of eight types of textured bottoms to prevent the cat litter from sticking to the bottom of the container.

If desired, the bottom portion of the cat litter box can include a disposable liner. Also, in an embodiment, the inside bottom texture is chosen to reduce the cat litter from sticking to the bottom of the container which makes it easier to clean and to remove clumped cat litter. Preferably, the shape of the bottom piece has a waste and is not square or oblong.

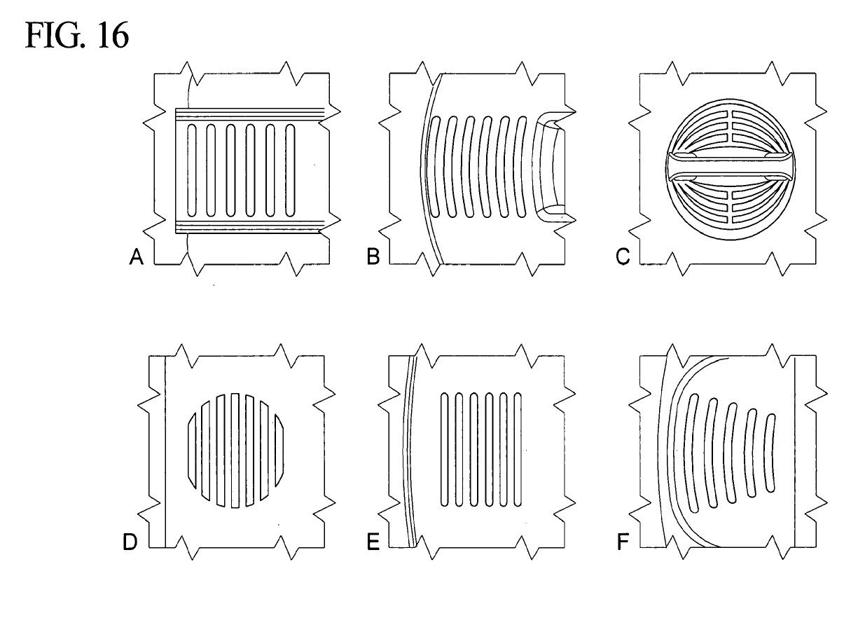

To reduce smell within the cat litter box, side vents are provided. The side vents increase the air flow within and through the interior. Moreover, by being placed on the side they prevent cat litter from being kicked out by the cat. A variety of vents can be provided as illustrated in FIG. 16 as A through F.

In order to ensure that the top portion of the cat litter box is coupled to the bottom portion, side locks are provided in a preferred embodiment. The side locks are preferably pressure side locks to removably lock or secure the top to the bottom.

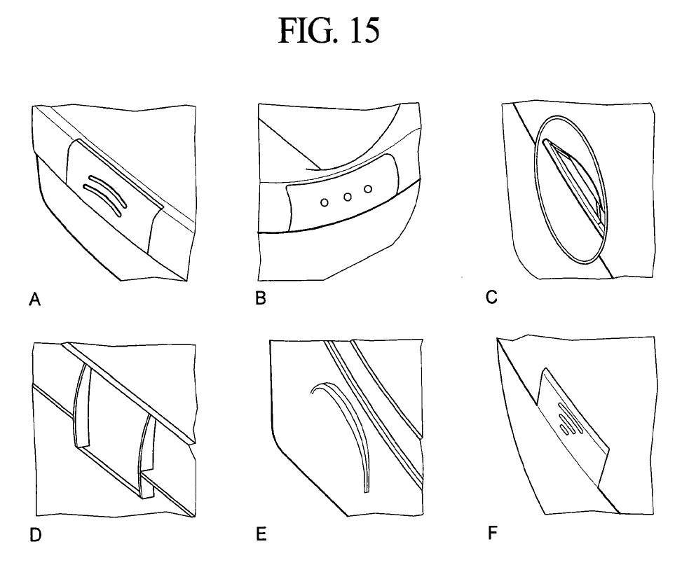

In order to allow the cat litter box to be easily transported, preferably a handle is located on the top of the litter box. The handle is used to carry the litter box. Preferably, the handle is molded to fit four fingers. In an embodiment, the handle is molded to encompass a finger grip. FIG. 15 illustrates a number of embodiments of the handle.

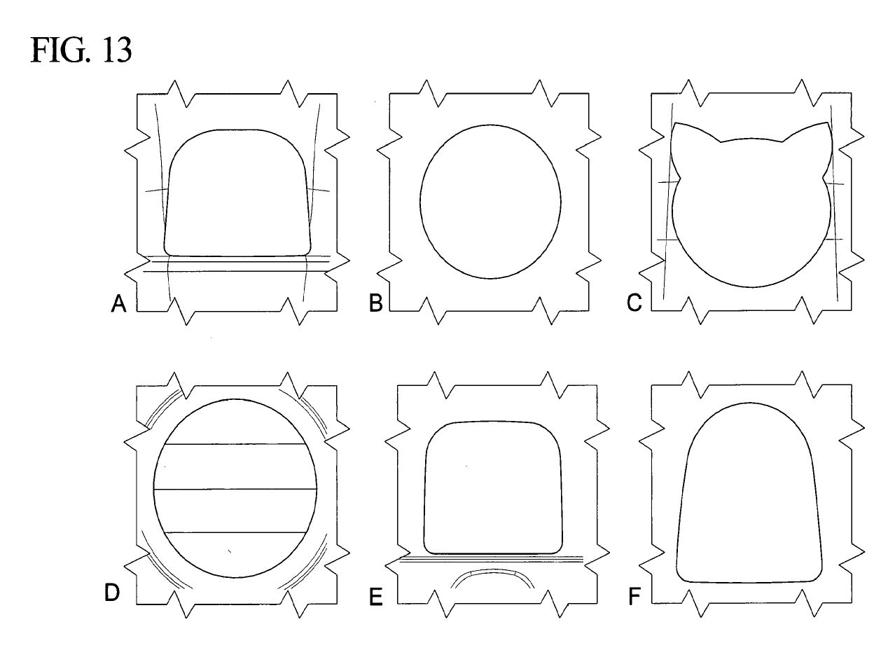

The opening of the cat litter box is designed to allow the cat, or other pet, to be able to enter the litter box. A variety of different openings can be utilized. FIG. 13 illustrates six embodiments of the opening. For example, FIG. 13C illustrates the shape of a cat's face as the opening to the cat box.

Preferably, located at the top of the litter box is a charcoal vent. The combination of the side vents and the front opening allow more efficient air flow for the charcoal. This is believed to result in a longer-lasting charcoal filter. In this regard, it is believed that the charcoal filter will only have to be replaced every month or two.

By way of example and not limitation, the structure of the cat litter box can be as follows:

Top and bottom made of Polypropylene Plastic

Front portion top made of Clarified Polypropylene Plastic

Front Portion Hinged at 50% of the top of the Cat Box

Pressure Front Locks on the Hinged portion of the Top of the Cat Box.

2 Pressure Side Locks

Tunnel Opening:

Dimensions: 7″×7″

Rectangular Shape:

Dimension 20″×15″×16″

Litter Box Thickness:

0.08″

Recessed Handle with indentions for finger grips

4″×6″ Charcoal Filter vent in the top back portion of the Cat Box—Odor Control

6—Vent slots in a Sinusoidal Wave Pattern

3″×3″ Side Vents on either side of the top portion of the Cat Box

5—slots on each vent—Increase Air Circulation to make the Charcoal Filter more efficient.

Both Sides of the bottom of the Cat Litter box are curved in ½″

Exterior Texture

Pebble Pattern AMT-9330 or 9225

Embossed Logo and lettering slick Smooth Surface AMT-9485 0.0005″ Deep

Interior of Bottom Textured:

Plaid Pattern AMT-9220 0.003″ Deep or Slick, Smooth Surface AMT-9485 0.0005″ Deep

Anti-microbial Agent from Microban.

If desired, the cat litter box can also include the following features:

Top and bottom made of Polystyrene, Polyester, Polyethylene Plastic or Clarified Polypropylene

Front portion top made of Styrene, Polyethylene, or Polypropylene Plastic

Front Portion Hinged at front, back or clam shell of the top of the Cat Box

No Pressure locks on the hinged portion.

2-4 Pressure Side Locks/Front Pressure locks

Round, Oval, Cat Face, Cat's Tail End, etc. Opening:

Dimensions: 6″-10″ in height and 6″-10″ in Width

Round, Octagon, Hexagonal Shape:

Dimension 14″-24″ in Length, 14″-24″ in Width×14″-24″ in Height

Litter Box Thickness:

0.03″-0.15″

Recessed Handle with indentions for finger grips

Charcoal Filter vent in the top back portion of the Cat Box: 3″-8″ in Width and 3″-10″ in Length

3-10 Vent slots in a Sinusoidal Wave Pattern, straight, curved, zigzag, etc.

Side Vents on either side of the top portion of the Cat Box: 1″-6″ Length and 1″-6″ in Width

2-8 slots on each vent at an 1-180 Degree angle

Both Sides of the bottom of the Cat Litter box are curved in ⅛″-3″

Exterior Texture

Pebble Pattern AMT-9330 or 9225

Embossed Logo and lettering slick Smooth Surface AMT-9485 0.0005″ Deep

Interior of Bottom Textured:

Plaid Pattern AMT-9220 0.003″ Deep or Slick, Smooth Surface AMT-9485 0.0005″ Deep

Anti-microbial Agent supplied by Microban or AgIon

Anti-Sticking Agents like Teflon, Silicone, and Polydimethyl Siloxane

Anti-Staining Agents like Silicone and Polycarbonate

Biodegradable Agents like polyhydroxybutyrate (PHB)

Litter Mat Accessory

Specifically Designed Liner.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-14. (canceled)

15. A pet litter box including a body defined by a top portion and a bottom portion, the top portion being detachable from and nestable within the bottom portion and including a door that is hingedly connected to the top portion of the body of the litter box to allow the door to be pivoted away from the top portion of the body, the door including an opening for allowing a pet to enter an interior defined by the body of the cat litter box.

16. The pet litter box of claim 15, wherein the litter box is designed for a cat.

17. The pet litter box of claim 15, wherein the opening is in the shape of a cat face.

18. The pet litter box of claim 15, wherein the interior is defined in part by a bottom portion and the bottom portion includes a textured portion.

19. The pet litter box of claim 15, wherein an outer portion of the litter box includes a handle.

20. The pet litter box of claim 15, including at least one side vent and a charcoal vent.

21. The pet litter box of claim 15, including a friction snap to allow the door that is hingedly connected to be removably secured to remaining portions of the body.

22. A cat litter box including a plastic body including a top and a bottom, the top and the bottom defining an interior therein including a bottom portion for receiving cat litter, the top of the body being detachable from and nestable within the bottom and including a door being hingedly connected thereto to allow the door to pivot, the door including an opening for allowing a cat to enter and exit the pet litter box, and the cat litter box including at least one side vent and a charcoal vent.

23. The cat litter box of claim 22, wherein the opening is in the shape of a cat face.

24. The cat litter box of claim 22, wherein the interior is defined in part by a bottom portion and the bottom portion includes a textured portion.

25. The cat litter box of claim 22, including a friction snap to allow the door that is hingedly connected to be removably secured to remaining portions of the body.

26. The cat litter box of claim 22, wherein the body includes at least two side vents and a top handle.
